(19) United States
(12) Patent Application Publication
(10) Pub. No.: US 2024/0218305 A1
(43) Pub. Date: Jul. 4, 2024

(54) BEVERAGE PROCESSING METHOD AND APPARATUS

(71) Applicant: REDLAYER LTD, London (GB)

(72) Inventors: David Graham ROBERTSON, London (GB); Stefan Hartmut Heinrich LAUX, London (GB)

(21) Appl. No.: 18/558,053

(22) PCT Filed: May 27, 2022
(86) PCT No.: PCT/GB2022/051371

§ 371 Date: Oct. 30, 2023

(30) Foreign Application Priority Data
May 28, 2021 (GB) 2107705.2

(51) Int. Cl. C12G 3/07

(52) U.S. Cl. CPC C12G 3/07

(57) ABSTRACT

The present invention provides an apparatus and method for processing a beverage. The apparatus comprises: an input, an output, a sonication chamber defined in a flow path between the input and the output, a pump configured to move a suspension through the sonication chamber towards the output, and a sonotrode configured to sonicate the matter suspension as it passes through the sonication chamber. At any position in the sonication chamber, a wall of the sonication chamber is provided within less than 3 centimetres of the position.

### FIELD OF THE INVENTION

The present invention relates to a method of flavouring a beverage, and apparatus for the same. The present invention also relates to an intermodal shipping container housing the apparatus.

### BACKGROUND TO THE INVENTION

Flavouring of alcoholic beverages is traditionally achieved through long maturation periods in wooden barrels or casks.

U.S. Pat. No. 4,210,676A dates from the 1970's and relates to a process and apparatus for the acceleration of the ripening of spirits. The patent details processing of the spirits with ultrasonic energy in the presence of wood staves.

It is in this context that the present invention has been devised.

### SUMMARY OF THE INVENTION

In accordance with an aspect of the present invention, there is provided a method of flavouring a beverage in a beverage processing apparatus. The apparatus comprises: an input; an output; a sonication chamber defined in a flow path between the input and the output; a pump configured to move matter through the sonication chamber towards the output; and a sonotrode configured to sonicate the matter as it passes through the sonication chamber. The method comprises: providing a suspension of a plurality of solid biological particles suspended in a beverage; pumping, using the pump, the suspension through the sonication chamber; sonicating, using the sonotrode, the suspension as it passes through the sonication chamber; and outputting, at the output, a flavoured beverage. At any position in the sonication chamber, a wall of the sonication chamber is provided within less than 3 centimetres of the position.

Sonicating the suspension typically causes the release of one or more organoleptic components from the biological particles. As a result, a flavour of the beverage can be altered, resulting in a flavoured beverage.

Thus, by providing an in-line sonication chamber having a relatively small size, even and consistent sonication of the suspension can be achieved. The present inventors have realised that in sonication chambers having an increased distance between an active surface of the sonotrode and an opposite wall of the sonication chamber (between which matter to be sonicated is provided), there would be an increased chance that more than one solid biological particle might be encountered by a sound wave radiating from the active surface towards the opposite wall of the sonication chamber. On encountering a first solid biological particle, at least some of the energy in the sound wave is transferred to the solid biological particle, causing the desired release of one or more organoleptic components from the solid biological particle. For any further solid biological particle(s) shielded from the sound wave by the first solid biological particle, less, or even none of the energy in the sound wave is transferred to the further solid biological particle(s). Accordingly, some of the solid biological particles may not release as much, or even any, of the desired organoleptic components into the surrounding beverage. Although it may be possible to increase an amplitude of the sound wave, to increase the energy in the sound wave, to ensure that there is a greater chance that a sound wave of sufficient energy can continue through the first solid biological particle to any further solid biological particle(s), this may cause extraction of undesirable (e.g. bitter) organoleptic components from the first solid biological particle due to the increased energy. Furthermore, consistency of the resulting flavoured beverage can also be reduced with sonication chambers having the increased distance between the active surface of the sonotrode and the opposite wall of the sonication chamber, because it is not possible to accurately predict when all of the solid biological particles have been subject to a given level of organoleptic component extraction. As a result, the flavour profile of two flavoured beverages, each subject to the same duration of sonication and other processing properties, in the same apparatus, may nevertheless still differ.

The inventors have overcome these problems by providing an in-line sonication chamber having only a relatively small distance between the active surface of the sonotrode and the opposite wall of the sonication chamber, such that there is a decreased chance that multiple solid biological particles will be encountered by sound waves emitted from the active surface of the sonotrode. Accordingly, the desired flavour profile can be more readily obtained. Additionally, the desired flavour profile can be obtained with more consistency.

It will be understood that where the sonotrode is provided within the sonication chamber, a surface of the sonotrode itself can provide at least one of the walls of the sonication chamber (e.g. an internal wall of the sonication chamber). Thus, energy is transmitted particularly effectively into the sonication chamber.

The one or more organoleptic components are typically chemicals. The chemicals may be lactones, tannins, phenolics, esters, acids, and/or aldehydes.

It may be that at any position in the sonication chamber, a wall of the sonication chamber is provided within less than 1 centimetre of the position, in some examples within less than 0.5 centimetres of the position. Thus, it is expected that only one, or only a small number of, solid biological particle(s) is/are in the path of a sound wave during sonication of the suspension, resulting in more consistent flavouring and/or the avoidance of undesirable flavour characteristics.

Sonication may occur primarily in a sonication region of the sonication chamber. It may be that the entire sonication region is within 3 centimetres of a wall of the sonication chamber, for example within 1 centimetres of a wall, such as within 0.5 centimetres of a wall.

Viewed another way, an extent of the sonication chamber in a direction transverse to a direction of flow through the sonication chamber, from an active surface of the sonotrode to an opposite wall of the sonication chamber, may be less than 6 centimetres, for example less than 2 centimetres, such as less than 1 centimetre. The direction may be perpendicular to the active surface of the sonotrode.

The beverage may be an alcoholic beverage and the suspension may be an alcoholic suspension.

The solid biological particles may be greater than 0.1 percent by weight of the suspension. The solid biological particles may be greater than 0.5 percent by weight of the suspension. The solid biological particles may be greater than 1 percent by weight of the suspension. The solid biological particles may be greater than 2.5 percent by weight of the suspension. The solid biological particles may be less than 20 percent by weight of the suspension. The solid biological particles may be between 1 and 20 percent by weight of the suspension. Thus, the flavouring of the beverage is not overpowered by the biological particles.

Sonicating the suspension may comprise providing a total sonication energy input to the suspension of at least 20 joules per gram of suspension. Sonicating the suspension may comprise providing a total sonication energy input to the suspension of less than 70 joules per gram of suspension. Thus, the energy input into the suspension by sonication is sufficient to extract flavouring compounds from the solid biological particles, without wasting energy or causing extraction of undesirably harsh flavouring compounds.

Sonicating the suspension may use sound having an amplitude greater than 10 μm. Sonicating the suspension may use sound having an amplitude less than 60 μm. Sonicating the suspension may use sound having an amplitude less than 40 μm. Sonicating the suspension may use sound having an amplitude between 10 μm and 40 μm. Thus, the amplitude of the sound input into the suspension by sonication is sufficient to extract desirable flavouring compounds from the solid biological particles, without causing extraction of undesirably harsh flavouring compounds.

Sonicating the suspension may use sound having a frequency of greater than 10 KHz. Sonicating the suspension may use sound having a frequency of greater than 15 KHz. Sonicating the suspension may use sound having a frequency of less than 70 KHz. Sonicating the suspension may use sound having a frequency of less than 50 KHz. Sonicating the suspension may use sound having a frequency of 20 KHz. The sound may be ultrasound.

The sonotrode may be provided internally within the sonication chamber, such that the suspension passes through the sonication chamber, and around the sonotrode. An active surface of the sonotrode may define a plurality of protuberances extending radially into the sonication chamber. Thus, the surface area of the sonotrode is increased, by virtue of the transition regions between the protuberance region and an un-protruded region of the sonotrode, and further because the protuberance region has a greater diameter (where the sonotrode is substantially cylindrical in shape) than an un-protruded region of the sonotrode.

The method may further comprise soaking the solid biological particles in the beverage prior to sonicating the suspension. Thus, the solid biological particles can be wetted in the beverage to improve the homogeneity of the mixed suspension, as well as to improve flavour extraction. The soaking may be for at least ten minutes. The soaking may be for at least thirty minutes. The soaking may be for at least two hours. The soaking may be for less than a week. The soaking may be for less than 48 hours. The soaking may be for less than 24 hours. In some examples, it may be that soaking is not necessary.

The method may comprise circulating the suspension through the sonication chamber a plurality of times. In other words, it may be that a given portion of the suspension would pass through the sonication chamber several times before flavour extraction from the solid biological particles is complete. Compared to systems in which sonication occurs in a single large tank or vat of liquid, use of a smaller sonication chamber ensures more even and consistent sonication of the liquid. The speed of flow through the sonication chamber may be controlled to achieve the desired flavouring result. The method may comprise pumping, using the pump, the suspension through the sonication chamber a plurality of times. In other words, it may be that a given portion of the suspension would be pumped into the sonication chamber at a first end, be pumped through the sonication chamber to a second end, and pumped around the rest of the flow path to return to the first end, a plurality of times. In this way, it will be understood that the suspension truly passes through (into and out of) the sonication chamber a plurality of times.

The flow path may be formed in part by the sonication chamber, and further by one or more conduits in fluid communication with the sonication chamber, the pump, the input of the apparatus and the output of the apparatus. The one or more conduits may provide a flow path from an output of the sonication chamber to an input of the sonication chamber, via the pump. Thus, the suspension can be circulated through the sonication chamber and the one or more conduits using the pump. It will be understood that the sonication chamber, the one or more conduits and the pump may form a closed loop.

Typically, the input and the output of the apparatus are each in the flow path. In some examples, the input and/or the output of the apparatus are accessed by a dedicated conduit.

The solid biological particles may comprise plant matter. The plant matter may comprise wood. The plant matter may comprise one or more nuts. The plant matter may comprise one or more herbs. The plant matter may comprise one or more spices. The plant matter may comprise one or more fruits (e.g. dried fruits). In some examples, the plant matter may comprise at least one of: wood, one or more nuts, one or more herbs; one or more spices, and one or more fruits (e.g. dried fruits). In some examples, the solid biological particles may comprise a mixture of different components. For example, the solid biological particles may comprise wood and one or more spices.

Where the plant matter comprises wood, the wood may be at least one of Quercus robur (European oak) and Quercus alba (North American oak).

Each of the solid biological particles may have a volume less than 3 cm³. At least 90% of the solid biological particles may have a volume less than 1 cm³. At least 95% of the solid biological particles may have a volume less than 1 cm³. Each of the solid biological particles may have a volume less than 1 cm³. At least 90% (such as at least 95%, sometimes each) of the solid biological particles may have a maximum length of less than 25 mm. At least 90% (such as at least 95%, sometimes each) of the solid biological particles may have a maximum width (orthogonal to the length) of less than 25 mm. At least 90% (such as at least 95%, sometimes each) of the solid biological particles may have a maximum depth (orthogonal to the length and the width) of less than 10 mm. At least 90% (such as at least 95%, sometimes each) of the solid biological particles may have a maximum diameter (orthogonal to the length and the width) of less than 10 mm. In some examples, the solid biological particles may have an approximate size of 8 mm long×3 mm wide×1 mm deep. Thus, the solid biological particles are fairly small, resulting in a more homogenous suspension than would be possible with larger particles.

The solid biological particles may be formed by chipping. In other examples, the solid biological particles may be formed by cutting into ribbons. It has been found that the size of the solid biological particles is particularly important. If the solid biological particles are too large, then the surface area of the solid biological particles relative to their volume is relatively small, with the result that the extraction of organoleptic compounds from the solid biological particles is also relatively poor. On the other hand, if the solid biological particles are too small, the surface area of the solid biological particles relative to their volume is much larger, meaning that the organoleptic compound extraction from the solid biological particles is much more intense, which can sometimes be undesirable. Furthermore, it has also been found that if the solid biological particles are too small, the solid biological particles, e.g. wood, is more likely to disintegrate, forming a thick slurry instead of a suspension. The thick slurry may result in blockage of the apparatus, preventing the apparatus from working to flavour a beverage.

In particular, at least 90% of the solid biological particles may have a volume greater than 1 mm³. At least 95% of the solid biological particles may have a volume greater than 1 mm³. Each of the solid biological particles may have a volume greater than 1 mm³. At least 90% (such as at least 95%, sometimes each) of the solid biological particles may have a length (a largest dimension) of greater than 2 mm. At least 90% (such as at least 95%, sometimes each) of the solid biological particles may have a width (orthogonal to the length) of greater than 0.5 mm. At least 90% (such as at least 95%, sometimes each) of the solid biological particles may have a depth (orthogonal to the length and the width) of greater than 0.5 mm. A length of at least 90% (such as at least 95%, sometimes each) of the solid biological particles may be greater than a width or a depth, each orthogonal to the length. Thus, the solid biological particles may be elongate in some way.

Where the solid biological particles are formed by chipping, a minimum size of each solid biological particle may be at least 5 mm×5 mm×2 mm, and a maximum size of each solid biological particle may be less than or equal to 10 mm×5 mm×2 mm. Where the solid biological particles are formed in ribbons, a minimum size of each solid biological particle may be at least 4 mm×1 mm×0.5 mm, and a maximum size of each solid biological particle may be less than or equal to 8 mm×1 mm×0.5 mm. Where the solid biological particle is formed from wood, it may be that a direction of the grain is along a dimension having a greatest extent, such as a length.

The method may further comprise controlling a temperature of the suspension to be less than a maximum temperature. The maximum temperature may be less than 35° C. The method may comprise cooling to control the temperature. Thus, elevated temperatures, which may alter the flavour extraction process, are avoided.

The method may further comprise controlling a pressure of the suspension in the apparatus to be less than a maximum pressure. The maximum pressure may be less than 1.5 bar (150,000 pascals). The method may comprise venting to reduce the pressure. Thus, elevated pressures, which may alter the flavour extraction process, are avoided. The apparatus may comprise a pressure relief valve. The apparatus may comprise a controllable valve to release pressure therefrom.

The method may further comprise providing the beverage and, separately, the solid biological particles. The method may further comprise mixing the beverage with the solid biological particles to provide the suspension. Thus, the solid biological particles can be distributed throughout the suspension. The mixing may be vortex mixing (e.g. using a vortex mixer). The mixing may be by using a tangential mixer.

The method may further comprise, after sonicating the suspension, filtering the suspension. Thus, at least some of the solid biological particles can be separated from the beverage prior to outputting the flavoured beverage. In some examples, substantially all of the solid biological particles may be separated from the beverage by filtering. The filtering may comprise a plurality of filter steps, together having a plurality of filter sizes. For example, a first filter step may be configured to filter particles less than a first filter size, and a second filter step, downstream of the first filter step, may be configured to filter particles less than a second filter size, smaller than the first filter size. The first filter size may be less than 2000 microns, such as less than 1000 microns, for example 200 microns. The second filter size may be less than 100 microns, for example 25 microns. A third filter step, downstream of the second filter step, may be configured to filter particles less than a third filter size, smaller than the second filter size. The third filter size may be less than 10 microns, such as 2.5 microns. The filter sizes may each be greater than 1 micron.

In some examples, the third filter step may be configured to be used only when the liquid is to be finally output from the apparatus, but the first and second filter step can be used repeatedly during a filtering recirculation process of the method.

The plurality of solid biological particles may be formed by cutting (for example shredding) one or more solid biological objects. Thus, a larger biological particle may be reduced in size by shredding.

The plurality of solid biological particles may be heat-treated. Thus, it may be that the organoleptic compounds in the solid biological particles can be more readily extracted following heat-treatment. In some examples, the organoleptic compounds extracted from the biological particles may be modified as a result of heat-treatment. The heat treatment may comprise at least one of heating, toasting, and charring.

Where the heat treatment is toasting, it may be that the toasting comprises applying infrared radiation to the solid biological particles. The infrared radiation may be applied using infrared heating panels. Where the solid biological particles comprise wood, it has been found that toasting using infrared radiation results in a conformational change in the wood lipid and lignin content. The result is a ‘toast gradient’—which unlike uniform convection heating—provides a spectrum of degraded wood constituents. Such varying proportions of lignin-derived compounds for instance, including terpenes vanillin, guaiacol and eugenol, infuse the spirit upon combination with a complex and uniquely balanced flavour. This is key to extracting a wide variety of flavour substances in a single operational run. This is, for some wood extractive flavours, similar to traditional oak cask maturation flavour extraction. Thus, toasting using infrared radiation typically results in a wide array of heat-treated oak flavour compounds (when the solid biological particles are oak).

In other examples, the toasting comprises toasting by convection. It will be understood that convection heating utilises hot air to toast the solid biological particles, resulting in a more homogenous toast profile. It has been found that toasting by convection is most desirable for the focused heat-treatment of wood when wanting to produce a singularly intensified flavour compound.

Viewed from a further aspect, the present invention provides an apparatus for processing a beverage. The apparatus comprises: a sonication chamber; a pump configured to move a suspension through the sonication chamber; and a sonotrode configured to sonicate the suspension as it passes through the sonication chamber. At any position in the sonication chamber, a wall of the sonication chamber is provided within less than 3 centimetres of the position.

Viewed from another aspect, the present invention provides an apparatus for processing a beverage. The apparatus comprises: an input; an output; a sonication chamber defined in a flow path between the input and the output; a pump configured to move a suspension through the sonication chamber towards the output; and a sonotrode configured to sonicate the suspension as it passes through the sonication chamber. At any position in the sonication chamber, a wall of the sonication chamber is provided within less than 3 centimetres of the position. Thus, the apparatus is suitable for use in the described method. Beverage received in the input of the apparatus can be pumped through the sonication chamber, together with a plurality of solid biological particles, where the combined suspension is sonicated to release the organoleptic compounds in the solid biological particles, to flavour the beverage. The flavoured beverage can be collected at the output.

The apparatus may be configured to carry out at least the pumping and the sonicating.

The pump may be a positive displacement pump. It will be understood that a positive displacement pump is sometimes referred to as a progressive cavity pump. Thus, the suspension, including the plurality of solid biological particles, can be pumped effectively through the sonication chamber, which may be difficult with other types of pump. Furthermore, mechanical cavitation of the suspension can be reduced or even entirely avoided using a positive displacement pump. The pump may be a screw pump.

The apparatus may comprise one or more filters between the sonication chamber and the output. A first filter may have a first filter size of less than 2000 microns (for example 1000 microns, or even 200 microns). A second filter, downstream of the first filter, may have a second filter size of less than 100 microns (for example 25 microns). A third filter, downstream of the second filter, may have a third filter size of less than 10 microns (for example 2.5 microns). The filters may each have a filter size greater than 1 micron.

It may be that the third filter is arranged only to be used when the flavoured beverage is to be finally output from the apparatus, but the first and second filter can be arranged to be used repeatedly during a filtering recirculation process performed by the apparatus.

The filter may be provided outside the flow path. In other words, the suspension can be circulated around the flow path including the sonication chamber a plurality of times without passing through the filter during each circulation. Thus, the solid biological particles can be disbursed throughout the flow path around which the suspension is pumped, including the sonication chamber, even though sonication occurs only in the sonication chamber. This allows a far higher mass of solid biological particles to be mixed with the beverage than if the solid biological particles were present only in the sonication chamber. The one or more filters are used to remove the solid biological particles from the suspension when the flavoured beverage is ready to be extracted from the apparatus through the output.

The apparatus may further comprise a controller configured to control at least one of the pump and the sonotrode in dependence on a desired flavour profile of the beverage. The controller may be configured to control the mixer. The controller may be configured to control a motor speed of the mixer. The controller may be configured to control a flow rate of the pump. The controller may be configured to modulate a motor of the pump to control a flow rate of the pump. The controller may be configured to control an amplitude of the sonotrode. The controller may be configured to control a frequency of the sonotrode. The controller may be configured to control an operating time of the sonotrode. The controller may be configured to receive one or more feedback signals indicative of at least one of flow rate, temperature and pressure and to control at least one of the pump, the sonotrode and the mixer in dependence thereon. It will be understood that the feedback signals can be used to create a feedback control loop for control of the apparatus.

The controller may comprise one or more processors and a non-transient, computer-readable memory storing instructions to cause the one or more processors to carry out the operations of the controller. The one or more processors may be provided in a single package, or may alternatively be distributed. Where the one or more processors are distributed, it will be understood that the distribution may be local or may be remote, with at least one of the one or more processors in data communication with other components of the controller in a separate package, for example via the internet.

A capacity of the apparatus may be at least 100 litres of beverage. The capacity may be at least 500 litres. The capacity may be less than 10,000 litres.

The present invention extends to an intermodal shipping container housing the apparatus. The present inventors have realised that there may be intense commercial interest in the recipes and processes used to extract flavour into a beverage. Even when the process is to be used on-behalf of a paying client, who provides the beverage, controlled access to the apparatus can be maintained by providing the beverage in a shipping container, which can be easily closed. If attempts to access detailed information about the apparatus are made, the intermodal shipping container can easily be closed and moved away from the on-site location in a short period of time, such as a matter of hours.

It may be that the apparatus is in an operating configuration (when housed in the intermodal shipping container). It may be that the apparatus can be operated when housed in the intermodal shipping container. Thus, by operating the apparatus within the intermodal shipping container, the operating environment can be more easily monitored and controlled than were the apparatus to be installed in a factory building, the conditions of which may change significantly between locations.

The intermodal shipping container may conform to ISO 668. The intermodal shipping container may be a standard 40-foot (approximately 12 metres) intermodal shipping container. Specifically, a length of the intermodal shipping container may be at least 12 metres, for example approximately 12150 millimetres. A width of the intermodal shipping container may be at least 2 metres, for example approximately 2400 millimetres. A height of the intermodal shipping container may be at least 2.5 metres, for example approximately 2800 millimetres.

It will be understood that where the term intermodal shipping container is used, it is to be understood to mean any of the sizes of intermodal freight shipping containers conforming to any of the ISO 668-Series 1 freight container designations. In particular, the intermodal shipping container may be any of the intermodal freight shipping containers sometimes referred to as 20 foot, 20 foot standard, 10 foot, 30 foot, 30 foot standard, 30 foot high cube, 40 foot, 40 foot standard, 40 foot high cube, 45 foot standard and 45 foot high cube.

It will be understood that the intermodal shipping container comprises one or more lockable doors, and may be windowless in a region in the shipping container in which the apparatus is located.

The method may further comprise sampling the suspension after sonication has been initiated. Thus, a portion of the suspension can be removed for sampling. This can be used to decide when the beverage is sufficiently flavoured. The method may further comprise determining an organoleptic indicator indicative of a progression of the flavouring of the beverage. The method may comprise ceasing the sonication of the suspension in dependence on the determined organoleptic indicator. Thus, the sonication can be stopped when the flavouring of the beverage reaches a predetermined stage.

The method may comprise, subsequent to outputting of the flavoured beverage, flushing the sonication chamber with cleaning fluid (e.g. water). Thus, the system can be cleaned. The flushing can also be used to remove waste solid biological particles from the apparatus.

The alcoholic beverage may have an alcohol percentage of less than 85% by volume. The alcoholic beverage may have an alcohol percentage of less than 50% by volume. The alcoholic beverage may have an alcohol percentage of more than 1% by volume. The alcoholic beverage may have an alcohol percentage of more than 4% by volume.

The non-alcoholic beverage may have an alcohol percentage of less than 2% by volume, for example less than 1% by volume, such as substantially 0% by volume.

In some examples, the method and apparatus may be used for flavouring a non-alcoholic beverage. The non-alcoholic beverage may be a non-alcoholic spirit, such as a non-alcoholic gin. The non-alcoholic beverage may be a non-alcoholic beer.

Although the present invention has been described in relation to a beverage, it will be understood that the method and apparatus may also be used for flavouring other liquid foodstuffs, such as condiments, for example vinegar.

The beverage may be a low-alcohol beverage, that is a beverage having an alcohol significantly less than is common for alcoholic beverages of the same type, for example less than half the proportion of alcohol.

### DESCRIPTION OF THE DRAWINGS

An example embodiment of the present invention will now be illustrated with reference to the following Figures in which:

FIG. 1 is a schematic diagram of an example of apparatus according to the present invention;

FIG. 2 shows an example of a sonication chamber according to the present invention;

FIG. 3 shows an example of a sonication device to cause sonication in the sonication chamber of FIG. 2;

FIGS. 4a and 4b show an illustration of an example of apparatus according to the present invention;

FIG. 5 shows a schematic diagram of an apparatus including a controller according to the present invention; and

FIG. 6 shows a flowchart illustrating a method of flavouring an edible liquid according to the present invention.

### DETAILED DESCRIPTION OF AN EXAMPLE EMBODIMENT

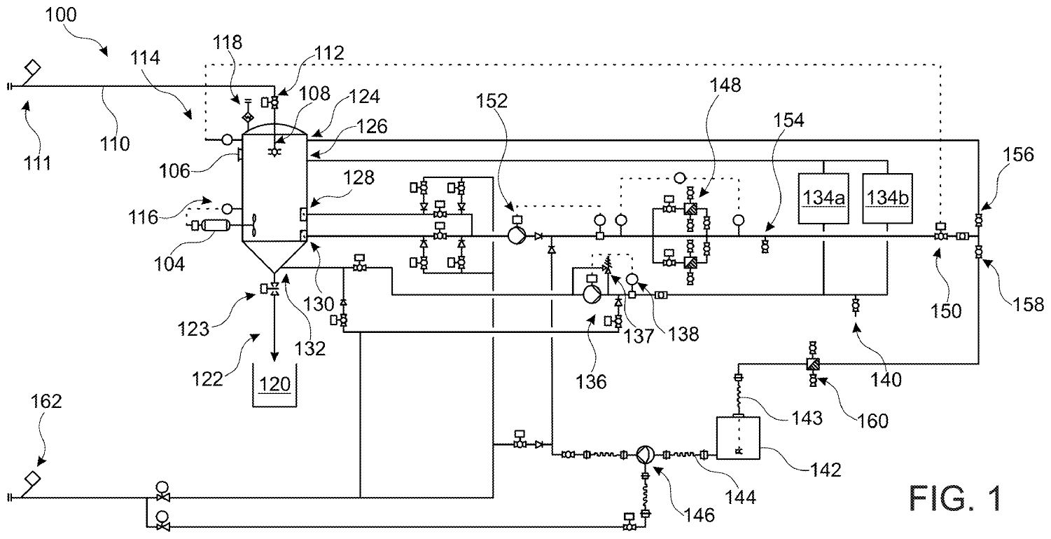

FIG. 1 is a schematic diagram of an example of apparatus according to the present invention. The apparatus 100 is for use in processing beverages, specifically for flavouring beverages. The beverage processing apparatus 100 comprises a plurality of different components, interconnected by a series of fluid flow conduits, to allow the apparatus to process beverages as described herein.

Specifically, the apparatus 100 comprises a storage container 102, in the form of a tank 102. The tank 102 is typically of a substantially cylindrical shape, though this is not intended to be limiting. The tank 102 has a working capacity of 1,000 litres. The tank 102 is provided with a mixer 104, in the form of a tangential mixer 104 to cause effective and efficient mixing of the contents of the tank 102, even when the tank 102 contains a mixture of liquid and solid biological particles, such as wood shreds. The mixer 104 is an electronically controlled mixer 104. The tank 102 is also provided with an access door 106 in an upper region of a side wall of the tank 102. The access door 106 can be opened to allow solid biological particles to be inserted into the tank 102, and closed again to reseal the tank 102. The tank is also provided with a cleaning outlet 108 for providing a cleaning fluid to the tank 102. In this example, the cleaning outlet 108 is in the form of a spray nozzle 108, located at an upper region of the tank 102, and the cleaning fluid is water, to be supplied to the cleaning output 108 via a cleaning fluid conduit 110, connected to a water source 111. The supply of water into the tank 102 is controlled by operation of cleaning supply valve 112. The cleaning supply valve 112 is an electronically controllable flow valve for controllably allowing or preventing flow of fluid there through. The tank 102 is also provided with an upper level sensor 114 and a lower level sensor 116. The upper level sensor 114 is configured to output a sensor signal indicative of the fluid level in the tank 102 being above or below the upper level sensor 114. The lower level sensor 116 is configured to output a sensor signal indicative of the fluid level in the tank 102 being above or below the lower level sensor 116. The lower level sensor 116 is in data connection with the mixer 104 and is provided above the mixer 104. If the lower level sensor 116 detects that the fluid level in the tank is too low, the mixer 104 can be switched off to prevent damage and/or inefficient operation. A pressure relief valve 118, in the form of a vent 118 is provided at an upper portion of the tank 102, to prevent a dangerous build-up of excess pressure 8 in the tank 102 (or in any other part of the apparatus 100 in fluid connection with the tank 102. The tank 102 is fluidly connected to a waste tank 120 via a waste conduit 122 including a controllable flow valve 123. The waste conduit 122 is connected to the tank 102 at a lower end of the tank 102. The tank 102 is further provided with a first port 124, a second port 126, a third port 128, a fourth port 130 and a fifth port 132. The third port 128 and the fourth port 130 are each provided with a filter between the tank and fluid conduits extending from the third port 128 and the fourth port 130. The filters ensure that particulates having a size greater than a filter size can be removed from the liquid mixture.

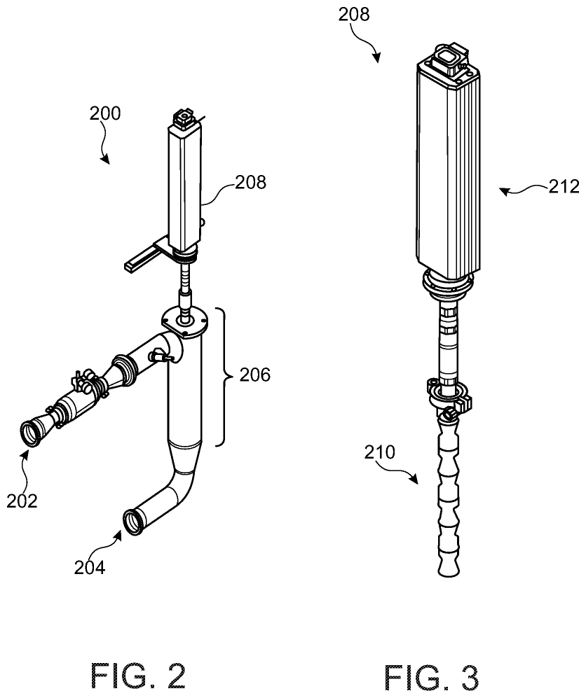

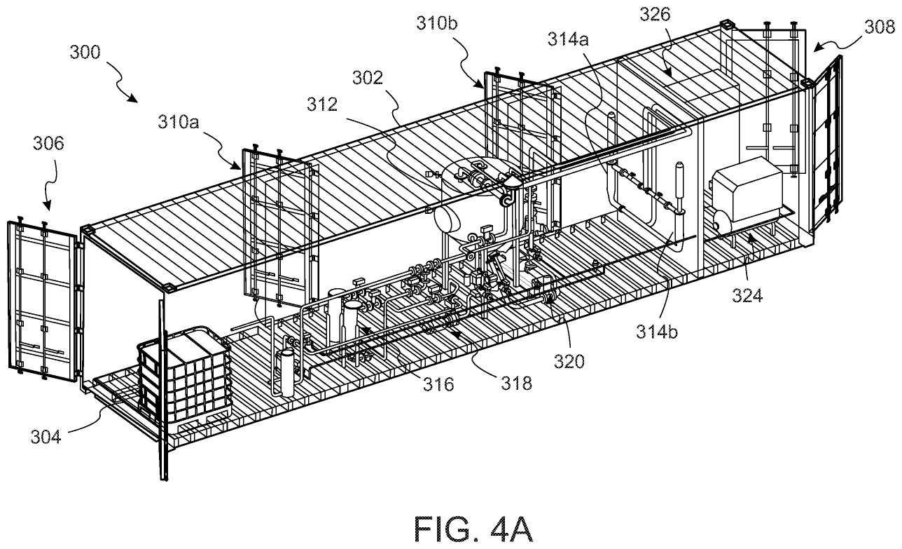

The apparatus 100 further comprises at least one sonication chamber 134a, 134b, in the form of two flow cells 134a, 134b. A first flow cell 134a is substantially identical to a second flow cell 134b, and will be described further with reference to FIGS. 2 and 3 hereinafter. The flow cells 134a, 134b are arranged to receive fluid from the tank 102 via the fifth port 132 and to return the fluid to the tank 102 via the second port 126. A sonication pump 136 is provided in the fluid flow path between the fifth port 132 and the flow cells 134a, 134b to pump the liquid mixture from the tank 102, through the flow cells 134a, 134b, and back to the tank 102 via the second port 126. The sonication pump 136 is provided with a pressure relief valve 137 to allow any excess pressure to be safely vented from the apparatus 100 should a blockage of the sonication pump 136 occur. A fluid sensor 138 is also provided and in data communication with the sonication pump 136 to cause the sonication pump 136 to cease operation if no fluid is detected by the fluid sensor 138, thereby preventing damage to the sonication pump 136. A sampling port 140 is provided in the fluid flow path between the fifth port 132 and the second port 126, specifically between the sonication pump 136 and the sonication chambers 134a, 134b. An operator can obtain a sample of the liquid mixture via the sampling port 140 for tasting or other analysis to determine whether sufficient sonication of the liquid mixture has occurred.

The base liquid for the liquid mixture is typically provided to the apparatus 100 from a further tank 142, in the form of a removable storage tank 142, such as an intermediate bulk container 142. A flexible outlet conduit in the form of a flexible hose 143 (sometimes referred to as the output) is inserted through an upper opening of the intermediate bulk container 142 for ejecting liquid into the intermediate bulk container 142, and a further flexible conduit 144 is connected to a lower port of the intermediate bulk container 142 for receiving liquid from the intermediate bulk container 142. A filling pump 146 is provided for pumping the liquid from the intermediate bulk container 142 to the tank 102, via the further flexible conduit 144, an intermediate filter arrangement and the first port 124. The intermediate filter arrangement 148 comprises at least one filter, in the form of two filters, each for removing particulates above a filter size of the filter(s) in the intermediate filter arrangement 148, from the liquid to be processed. A overfill protection valve 150 is provided in the fluid flow path between the intermediate bulk container 142 and the first port 124, specifically between the filter arrangement and the first port 124. The overfill protection valve 150 is an electronically controllable flow valve in data communication with the upper level sensor 114 and is configured to prevent fluid flow therethrough when the upper level sensor 114 indicates that the fluid level within the tank 102 is at or above the level of the upper lever sensor 114. In this way, overfilling of the tank 102 can be avoided.

The apparatus 100 further comprises a filter recirculation pump 152 in fluid communication on an input side with the tank 102 via the third port 128 and the fourth port 130, and in fluid communication on an output side with the tank 102 via the filter arrangement 148, the overfill protection valve 150 and the first port 124. A further sampling port 154 is provided in the fluid flow path between third and fourth ports 128, 130, and the first port 124 out with the tank 102, specifically between the filter arrangement 148 and the overfill protection valve 150.

The filter recirculation pump 152 is also in fluid communication with the intermediate bulk container 142 via the flexible hose 143. A recirculation flow valve 156 and a intermediate bulk container flow valve 158 are controlled in concert to direct fluid flow caused by operation of the filter recirculation pump 152 to one of the tank 102 via the first port 124 and the intermediate bulk container 142 via the flexible hose 143. The recirculation flow valve 156 and the intermediate bulk container flow valve 158 are each controllable flow valves configured to be electronically controllable. In this case, either the recirculation flow valve 156 can be open, permitting fluid flow between the filter arrangement 148 and the first port 124, and the intermediate bulk container flow valve 158 can be closed, preventing fluid flow between the filter arrangement 148 and the intermediate bulk container 142 via the flexible hose 143, or the recirculation flow valve 156 can be closed, preventing fluid flow between the filter arrangement 148 and the first port 124, and the intermediate bulk container flow valve 158 can be open, permitting fluid flow between the filter arrangement 148 and the intermediate bulk container 142 via the flexible hose 143. A further filter 160 is provided in the fluid flow path between the intermediate bulk container flow valve 158 and the flexible hose 143. In this way, the fluid can be further filtered just before being provided back into the intermediate bulk container 142.

The apparatus 100 is also provided with an air purging functionality for use in clearing blockages, as well as to aid emptying of fluid from the apparatus. Thus, a source of pressurised air 162 can be connected to the apparatus 100 via a series of controllable valves, as well as non-return valves (not labelled individually in FIG. 1 for brevity). Accordingly, substantially all of the fluid conduits in the apparatus 100 can be supplied with pressurised air to help remove any blockages in the pumps, filters, or any other components of the apparatus 100. In this example, the source of pressurised air 162 if provided by an air compressor (not shown).

Although not shown, it will be understood that each of the pumps is typically of different design; the sonication pump 136 is a positive displacement pump, allowing the pump to move a slurry formed of the liquid to be processed and the plurality of solid biological particles. The filling pump 146 is an air diaphragm pump. The filter recirculation pump 152 is a centrifugal pump.

In this example, the valves of the apparatus 100 are actuated by compressed air, also supplied by the air compressor (not shown), though the air connections to the actuation mechanism for each valve have not been shown for brevity.

An example operation of the apparatus 100 will now be described for an example of flavouring a base alcoholic beverage using wood shreds.

Firstly, a plurality of solid biological particles, in the form of wood shreds, each having a size of approximately 8 mm×3 mm×1 mm, are input into the tank 102 via the access door 106.

Next, the intermediate bulk container 142 is provided filled with a sufficient quantity of the base alcoholic beverage to fill most of the tank 102. The filled intermediate bulk container 142 is connected to the apparatus by having the flexible hose 143 inserted into the upper opening of the intermediate bulk container 142 and the further flexible conduit 144 connected to the lower port of the intermediate bulk container 142. The recirculation flow valve 156 is set to open and the intermediate bulk container flow valve 158 is set to closed, and the filling pump 146 is operated. The liquid from the intermediate bulk container 142 is drawn through the lower port of the intermediate bulk container 142, through the further flexible conduit 144, through the filling pump and is pumped to the tank 102 via the filter arrangement 148, the recirculation flow valve 156 and the first port 124. Once there is sufficient fluid in the tank 102, and/or when the intermediate bulk container 142 is emptied of liquid, the filling pump 146 is stopped. Air from the source of pressurised air 162 can be used to purge any remaining liquid mixture from the fluid conduits between the filling pump 146 and the first port 124 into the tank 102. In other examples, it will be understood that the base beverage might be added before the wood shreds.

Once the base alcoholic beverage and the plurality of solid biological particles are both provided in the tank, the mixer 104 is operated to ensure that the solid biological particles are sufficiently wetted by the base alcoholic beverage and are substantially uniformly distributed through the base alcoholic beverage, to form a substantially homogenous mixture (i.e. a suspension).

The mixture is then soaked for several hours, for example 4 hours. During soaking, the mixer 104 will be operated intermittently to ensure little or no settling of the solid biological particles occurs in the liquid mixture. It will be understood that in some examples, soaking is not required.

After the mixture is sufficiently wetted and soaked, the sonication pump 136 is operated and a sonotrode (see FIG. 3 for detailed description) in each of the flow cells 134a, 134b is activated. The liquid mixture is drawn from the tank 102 through the fifth port 132, through the sonication pump 136, and pumped through the flow cells 134a, 134b, arranged in parallel, and back into the tank 102 through the second port 126. In this way, the liquid mixture of the base alcoholic beverage and the solid biological particles is recirculated in a circuit including the tank 102 and the flow cells 134a, 134b. As described elsewhere herein, the sonotrodes apply ultrasonic sound energy to the liquid mixture. The sound has an amplitude of 20 μm and a frequency of 20 kHz, and is applied for a duration sufficient to cause energy transfer of 30 joules per gram of the liquid mixture. In an example with 500 litres of liquid and 15 kilograms of solid biological particles, this equates to an energy transfer of 15.45 megajoules to the liquid mixture. In this way, esters, acids and aldehydes in the solid biological particles are released into the liquid mixture. For example, it may be that the sonication pump 136 and the sonotrodes are operated for three hours. An operator extracts a sample of the liquid mixture at or towards the end of the sonication stage via the sampling port 140 to taste the liquid mixture and confirm that the sonication has completed correctly. After the predetermined time and/or when the operator is satisfied with the output, the sonication pump 136 and the sonotrodes in the flow cells 134a, 134b are switched off. Air from the source of pressurised air 162 can be used to purge any remaining liquid mixture from the fluid conduits between the fifth port 132 and the second port 126 back into the tank 102.

Once the flavour of the liquid mixture is sufficiently changed by the acids, esters and aldehydes released by sonication, it is necessary to filter the liquid mixture to remove most if not all of the solid biological particles from the liquid mixture. The recirculation flow valve 156 is set to open, the intermediate bulk container flow valve 158 is set to closed, and the filter recirculation pump 152 is operated. Liquid mixture is drawn from the tank 102 via the third port 128 and the fourth port 130 through the filter recirculation pump 152 and pumped through the filter arrangement 148 and back to the tank 102 via the recirculation flow valve 156 and the first portion 124. In this way, it can be seen that the liquid mixture is recirculated and repeatedly filtered. By recirculating the liquid mixture multiple times, the filters in the filter arrangement 148, and also the filters at the third and fourth ports 128, 130 are properly wetted, ensuring they perform effectively. The operator can obtain a sample of the filtered liquid mixture through the further sampling port 154 to check whether enough of the solid biological particles have been removed. Once the operator is satisfied, the filter recirculation pump 152 can be switched off. Air from the source of pressurised air 162 can be used to purge any remaining liquid from the fluid conduits between the third and fourth ports 128, 130 and the first port 124 back into the tank 102. Furthermore, it will also be understood that where the filters at the third and fourth ports 128, 130 become blocked during use, air from the source of pressurised air 162 can be used to unblock the filters and allow filtration of the liquid to continue.

To collect the sonicated, filtered liquid, the recirculation valve 156 is set to closed, the intermediate bulk container flow valve 158 is set to open, and the filter recirculation pump 152 is operated. It will be understood that in some examples, the filtering process may be changed to the liquid collection process simply by changing the state of the recirculation valve 156 and the intermediate bulk container flow valve 158 without switching off the filter recirculation pump 152. Liquid is drawn from the tank 102, through the third and fourth ports 128, 130, through the filter recirculation pump 152 and is pumped through the filter arrangement 148 and to the intermediate bulk container 142 via the intermediate bulk container flow valve 158, the further filter 160 and the flexible hose 143. In this way, the flavoured, filtered alcoholic beverage can be collected in the intermediate bulk container 142, having had the solid biological particles mostly, if not completely, removed.

The intermediate bulk container 142 can then be removed for further processing, for example for bottling of the alcoholic beverage.

Once the liquid has been removed back into the intermediate bulk container 142, cleaning and draining of the rest of the apparatus 100 can be completed. Cleaning fluid, in the form of water, can be injected into the tank 102 from the source of water 111, through the cleaning fluid conduit 110 and through the spray nozzle 108. It may be that the water is circulated around the various circuits of the apparatus 100, such as through the filter arrangement 148 and/or through the flow cells 134a, 134b, by operation of the filter recirculation pump 152 and the sonication pump 136 respectively. Air from the source of pressurised air 162 can also be used to purge any remaining liquid or solid biological particles from the fluid conduits back into the tank 102. The waste material (i.e. water and used solid biological particles) can be emptied from the tank 102 by opening the controllable flow valve 123, and allowing the waste to exit to the waste tank 120 via the waste conduit 122, typically under gravity. The tank 102 may be cleaned several times until all of the waste material has been removed.

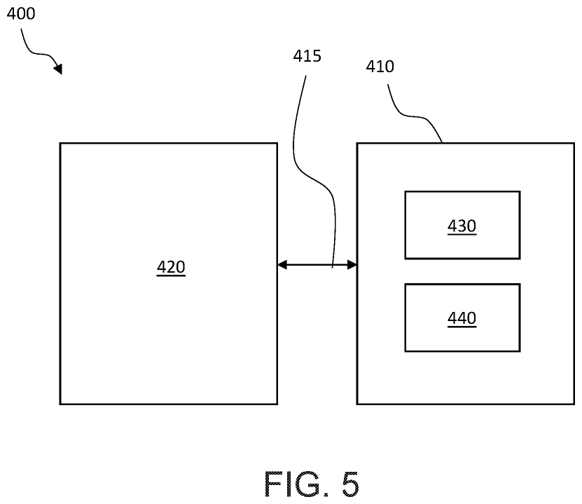

It will be understood that a controller for controlling the apparatus 100 is not shown in FIG. 1, but is typically provided in electronic data communication with the electronically controllable components of the apparatus 100. The controller is described further with reference to FIG. 5 hereinafter.

It will also be understood that the liquid mixture comprises the base liquid (e.g. beverage, or liquid foodstuff, such as condiment) mixed with the solid biological particles.

It will be understood that each of the valves described hereinbefore are electronically controllable flow valves for controllably allowing or preventing flow of fluid therethrough in response to electronic control signals, with the actuation of the valve being achieved using compressed air.

FIG. 2 shows an example of a sonication chamber according to the present invention. The sonication assembly 200, comprises a first port 202 and a second port 204. In use, the liquid mixture is caused to flow, for example by a pump (not shown), between the first port 202 and the second port 204, such as from the first port 202 to the second port 204. The sonication assembly 200 defines a sonication chamber 206, sometimes referred to as a flow cell, in a fluid flow path between the first port 202 and the second port 204. The sonication chamber 206 includes a sonication region, being the region of the sonication chamber 206 in which sonication primarily occurs during operation of the sonication assembly 200. The sonication assembly 200 further includes a sonication device 208 configured to cause sonication within the sonication chamber 206, and illustrated further with reference to FIG. 3 hereinafter. It will be understood that the sonication device 208 can be considered to provide an internal wall of the sonication chamber 206.

FIG. 3 shows an example of a sonication device 208 to cause sonication in the sonication chamber 206 of FIG. 2. The sonication device comprises a sonotrode tip 210 for mounting within the sonication chamber 206 of FIG. 2. The sonotrode tip 210 is caused to vibrate by the sonotrode driver 212, thereby causing sonication of the liquid mixture when flowing through the sonication chamber 206 as described hereinbefore. The sonication tip 210 is mounted substantially axially centrally within the sonication chamber 206, such that there exists only a small space between the surface of the sonication tip 210 and an internal facing surface of the sonication chamber 206.

The operation and assembly of sonotrodes will be well understood by the person skilled in the art.

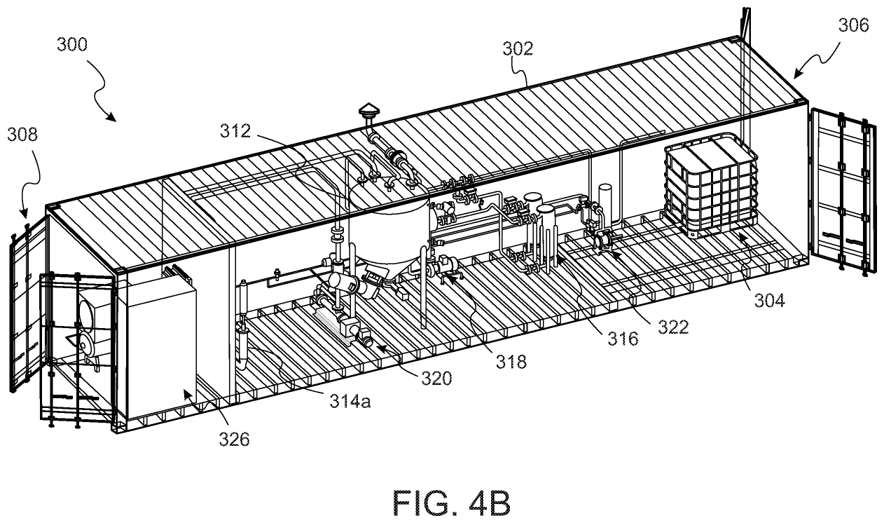

FIGS. 4a and 4b show an illustration of an example of apparatus according to the present invention. The apparatus 300 includes the components described herein before with reference to FIG. 1, provided in an intermodal shipping container 302, specifically a 40 foot intermodal shipping container (hereinafter referred to as a shipping container 302). The shipping container 302 includes the apparatus of FIG. 1, provided in an operating configuration. In other words, it is possible to use the components within the shipping container 302 to process beverage from an intermediate bulk container 304 whilst the components remain within the shipping container 302. The shipping container 302 is provided with a first opening 306 at a first end and a second opening 308 at a second end, opposite the first end. Two side openings 310a, 310b (not shown in FIG. 4b) are also provided to allow access to other regions of the shipping container 302. Each of the openings is provided with a lock (not shown). Within the shipping container 302, there is provided the tank 312, the sonication chambers 314a, 314b, the filter arrangement 316, the filter recirculation pump 318, the sonication pump 320 and the filling pump 322. An air compressor 324 is also provided for providing the source of compressed air for use in purging the conduits of the apparatus, as described hereinbefore, as well as for actuating the 12 valves, also as described hereinbefore. An operating terminal 326 is also provided for use by an operator to control operation of the apparatus 300.

FIG. 5 shows a schematic diagram of an apparatus including a controller according to the present invention. The apparatus 400 comprises a controller 410 and is configured to exchange signals 415 with sensing and controllable components 420 of the apparatus 400 to control the apparatus 400 in accordance with input signals received by the controller 410, for example from user inputs by an operator of the apparatus 400. The controller 410 in this example is realised by one or more processors 430 and a computer-readable memory 440. The memory 440 stores instructions which, when executed by the one or more processors 430, cause the apparatus 400 to operate as described herein.

Although the controller 410 is shown as being part of the apparatus 400, it will be understood that one or more components of the controller 410, or even the whole controller 410 can be provided separate from the sensing and controllable components 420 of the apparatus 400, for example remotely, to exchange signals with the sensing and controllable components 420 by wireless communication.

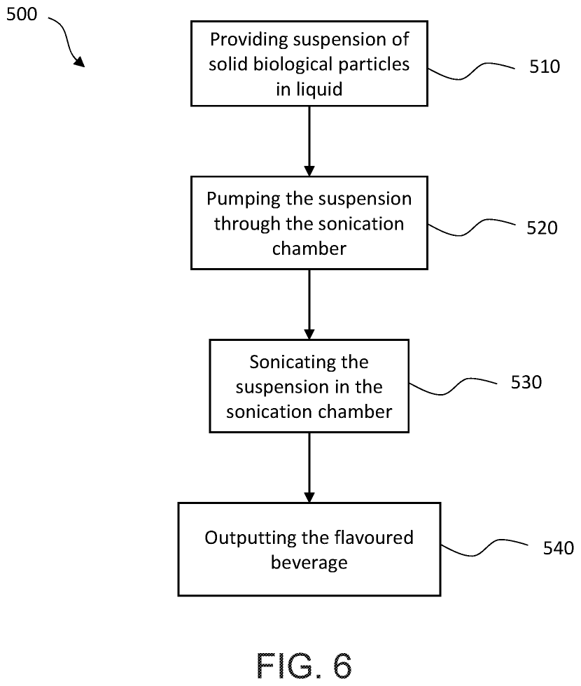

FIG. 6 shows a flowchart illustrating a method of flavouring an edible liquid (e.g. a beverage) according to the present invention. The method 500 is to be performed using the apparatus described hereinbefore with reference to FIGS. 1, 2, 3, 4a and 4b. Broadly, the method 500 comprises sonicating the edible liquid as it passes through the sonication chamber and outputting the flavoured liquid.

Specifically, the method 500 comprises providing 510 a suspension of a plurality of solid biological particles suspended in an edible liquid. In some examples, the suspension is mixed, and/or soaked for a period of time.

Subsequently, the method 500 comprises pumping 520 the suspension through the sonication chamber of the apparatus, using the pump (e.g. the sonication pump).

While the suspension is being pumped through the sonication chamber, the method 500 further comprises sonicating 530 the suspension as it passes through the sonication chamber, using the sonotrode. In this way, one or more organoleptic components (e.g., esters, acids and aldehydes) are released from the solid biological particles to alter a flavour of the beverage. Sonicating the suspension can comprise providing a total sonication energy input to the suspension of at least 20 joules per gram of suspension, with an amplitude of between 20 μm and 40 μm at a frequency of at least 20 KHz. Typically, the suspension is circulated through the sonication chamber a plurality of times.

The method 500 further comprises outputting 540 the flavoured beverage at the output. The flavoured beverage may be filtered prior to outputting, to remove some, or even all, of the plurality of solid biological particles.

In summary, there is provided an apparatus (100) for processing a beverage. The apparatus (100) comprises: an input (144), an output (143), a sonication chamber (134a, 134b) defined in a flow path between the input (144) and the output (143), a pump (136, 152) configured to move a suspension through the sonication chamber (134a, 134b) towards the output (143), and a sonotrode configured to sonicate the matter suspension as it passes through the sonication chamber (134a, 134b). At any position in the sonication chamber, a wall of the sonication chamber is provided within less than 3 centimetres of the position.

Throughout the description and claims of this specification, the words “comprise” and “contain” and variations of them mean “including but not limited to”, and they are not intended to and do not exclude other components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment, or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A method of flavouring a beverage in a beverage processing apparatus, the apparatus comprising:
an input;
an output;
a sonication chamber defined in a flow path between the input and the output;
a pump configured to move matter through the sonication chamber towards the output; and
a sonotrode configured to sonicate matter as it passes through the sonication chamber, the method comprising:
providing a suspension of a plurality of solid biological particles suspended in a beverage;
pumping, using the pump, the suspension through the sonication chamber a plurality of times;
sonicating, using the sonotrode, the suspension as it passes through the sonication chamber whereby to release one or more organoleptic components (e.g. esters) from the biological particles to alter a flavour of the beverage;
after the suspension has been pumped through the sonication chamber a plurality of times, filtering the suspension; and
outputting, at the output, the filtered, flavoured beverage,
wherein at any position in the sonication chamber, a wall of the sonication chamber is provided within less than 3 centimetres of the position.

2. The method of claim 1, wherein the solid biological particles are between 1 and 20 percent by weight of the suspension.

3. The method of claim 1, wherein sonicating the suspension comprises providing a total sonication energy input to the suspension of at least 20 joules per gram of suspension.

4. The method of claim 1, wherein sonicating the suspension uses sound having an amplitude of between 20 μm and 40 μm.

5. The method of claim 1, wherein sonicating the suspension uses sound having a frequency of at least 20 KHz.

6. The method of claim 1, further comprising soaking the solid biological particles in the beverage for at least thirty minutes prior to sonicating the suspension.

7. The method of claim 1, wherein the solid biological particles comprise plant matter.

8. The method of claim 7, wherein the plant matter comprises at least one of wood, nuts and spices.

9. The method of claim 1, wherein each of the solid biological particles have a volume less than 3 cm³.

10. The method of claim 1, further comprising controlling a temperature of the suspension to be less than a maximum temperature, the maximum temperature being less than 35° C.

11. The method of claim 1, further comprising controlling a pressure of the suspension in the apparatus to be less than a maximum pressure, the maximum pressure being less than 1.5 bar.

12. The method of claim 1, further comprising providing the beverage and, separately, the solid biological particles, and mixing the alcoholic beverage with the solid biological particles to provide the suspension.

13. The method of claim 1, wherein the plurality of solid biological particles are formed by shredding one or more solid biological objects.

14. The method of claim 1, wherein the plurality of solid biological particles are heat-treated.

15. An apparatus for processing a beverage, the apparatus comprising:
an input;
an output;
a sonication chamber defined in a flow path between the input and the output;
a pump configured to circulate a suspension through the sonication chamber a plurality of times;
a sonotrode configured to sonicate the suspension as it passes through the sonication chamber; and
one or more filters between the sonication chamber and the output, arranged to filter the suspension after it has been circulated through the sonication chamber the plurality of times,
wherein at any position in the sonication chamber, a wall of the sonication chamber is provided within less than 3 centimetres of the position.

16. (canceled)

17. The apparatus of claim 15, wherein the pump is a positive displacement pump.

18. The apparatus of claim 15, wherein the apparatus further comprises a controller configured to control at least one of the pump and the sonotrode in dependence on a desired flavour profile of the beverage.

19. The apparatus of claim 15, wherein a capacity of the apparatus is at least 500 litres of beverage.

20. An intermodal shipping container housing the apparatus of claim 15.

21. The intermodal shipping container of claim 20, wherein the apparatus is in an operating configuration.
